(19) United States
(12) Patent Application Publication
(10) Pub. No.: US 2026/0129434 A1
(43) Pub. Date: May 7, 2026

(54) Method for Configuring a Communication Device, Method for Configuring a Communication Device by Means of a User Device, Communication Device, System and Computer Program

(71) Applicant: Andreas Stihl AG & Co. KG, Waiblingen (DE)

(72) Inventor: Holger MOESSINGER, Winnenden (DE)

(21) Appl. No.: 19/381,414

(22) Filed: Nov. 6, 2025

(30) Foreign Application Priority Data
Nov. 7, 2024 (DE) 10 2024 132 507.0

(51) Int. Cl. H04W 12/04

(52) U.S. Cl. CPC H04W 12/04

(57) ABSTRACT

A method configures a communication device, which is suitable at least for: arrangement on a motor-driven processing device, collecting data from the processing device, cryptographically processing the collected data with a cryptographic key, wirelessly transmitting the processed data, and connecting to an electrical energy storage device for supplying the communication device with energy during the processing and transmission, and in particular collection, of the data. The method includes: transferring the communication device to a configuration state triggered by establishing the connection to the energy storage device by a user, such that the energy storage device supplies the communication device with energy, wherein in the configuration state the communication device is designed to wirelessly receive the key and accept the received key; receiving the key by the communication device in the configuration state; and configuring the communication device by the acceptance of the received key by the communication device, such that the configured communication device is configured for processing the data with the key and transmitting the processed data.

### CROSS REFERENCE TO RELATED APPLICATION

This application claims priority under 35 U.S.C. §119 from German Patent Application No. 102024132507.0, filed November 7, 2024, the entire disclosure of which is herein expressly incorporated by reference.

### BACKGROUND AND SUMMARY

The invention relates to a method for configuring a communication device, a method for configuring a communication device by means of a user device, a communication device, a system comprising such a communication device and a computer program for carrying out such a method and/or by means of such a communication device and/or by means of such a system.

The object addressed by the invention is the provision of a method for configuring a communication device, a method for configuring a communication device by means of a user device, a communication device, a system comprising such a communication device and a computer program for carrying out such a method and/or by means of such a communication device and/or by means of such a system, which have/has improved properties.

The invention solves this problem by providing methods, a communication device, a system and a computer program described in the independent claims. Advantageous refinements and/or embodiments of the invention are described in the dependent claims.

The method according to the invention is designed to configure a communication device at least once. The communication device is at least suitable, and configured, in particular after the configuration, for:

- arrangement on, in particular in, a motor-driven processing device,

- collecting data from the processing device, in particular when arranged on the processing device,

- cryptographically processing the collected data with a cryptographic key and/or by using the key,

- wirelessly transmitting the processed data, and

- connecting, in particular electrically, to an energy storage device for supplying the communication device with, in particular electrical, energy during or at least for the processing and transmission, and in particular the collection, of the data.

The method comprises the steps of:

a) transferring the communication device to a configuration state triggered by establishing the connection to the energy storage device by a user at least, in particular exactly or only once, in particular as a single or one-off action, in such a way that the energy storage device supplies the communication device with energy, wherein the communication device in the configuration state is designed to wirelessly receive the key and to accept the received key;

b) receiving the key by means of the communication device in the configuration state;

c) configuring the communication device by means of the acceptance of the received key by means of the communication device, in such a way that the configured communication device is configured for processing the data with the key and transmitting the processed data.

This enables the configuration of the communication device triggered by the user, in particular who may be or needs to be in actual possession of the communication device in order to establish the connection to the energy storage device. Thus, this enables the configuration to be secure, in particular protected against manipulation by an unauthorized person who cannot be in actual possession of the communication device. In addition or alternatively, this enables a simplicity of the communication device. In particular, the communication device may not or need not have a user-operable trigger, such as a button, for an operation by the user that is different from the establishment of the connection to the energy storage device in order to trigger the transfer of the communication device to the configuration state. Further, in addition or alternatively, this enables a resetting or a reset function or a reset in the form of a hard reset of the communication device, in particular into a factory or delivery state.

In particular, the method, the configuration, the collection, the processing, the transmission, the supply, the transfer, the reception and/or acceptance can be automatic and/or computer-implemented.

The term "initialize" or "set up" can be used synonymously for the term "configure".

The term "set up", "designed" or the phrase "programmed to perform the function/s of" can be used synonymously for the term "configured".

The arrangement can be implementable by the user, and in particular in a releasable, in particular non-destructively releasable, manner and/or in a contact-based manner and/or mechanically. In addition or alternatively, the arrangement may comprise, in particular be, an attachment or fastening or connection, in particular a materially bonded connection, such as an adhesive bond, a force-fitting connection, such as a latching or snap-in connection, and/or a positive-locking connection, such as a screw connection. Further, in addition or alternatively, the communication device can contact the processing device directly or immediately when arranged on the processing device.

The term "processing unit" or "tool" can be used synonymously for the term "processing device".

The processing device can be floor-mounted and/or user-guided, in particular hand-guided, in particular hand-held, and/or be a gardening, forestry, construction and/or ground treatment device. In particular, the hand-guided, in particular hand-carried, processing device can have a maximum mass of 50 kg (kilograms), in particular a maximum of 20 kg, in particular a maximum of 10 kg, in particular a maximum of 5 kg, and/or a minimum mass of 0.2 kg, in particular a minimum of 0.5 kg, in particular a minimum of 1 kg, in particular a minimum of 2 kg. In addition or alternatively, the gardening, forestry, construction and/or ground treatment device can be a saw, a high-level pruner, a hedge trimmer, a hedge cutter, a woodcutter, pruning shears, a blower, a leaf blower, a suction device, a garden vacuum cleaner, a cleaning device, a pressure washer, a spray and/or sprinkler device, a sweeper, a sweeping roller, a brush sweeper, a lawn mower, a grass cutter, a brushcutter, an angle grinder or a stone cutter or a combination device comprising more than one of the aforementioned gardening, forestry, construction and/or ground treatment devices.

The data and/or the key can have a value and/or content.

The communication device may be designed for the, in particular automatic, storage of the collected data, in particular in a memory of the communication device and/or on the condition that a drive motor of the processing device has been in an uninterrupted ON state for at least a predetermined duration, such as 1 s. In particular, the transmission may consist of the stored data.

The processing may comprise, in particular be, securing, protection, an encryption, in particular asymmetric encryption, and/or in particular an asymmetric generation of a digital signature. In addition or alternatively, the key may be public or non-secret, in particular for the encryption and/or belonging to the user, in particular uniquely assigned to an account of the user, and/or private or secret, in particular for the generation and/or belonging to the user.

The term "wireless" can be used synonymously for the term "cable-less".

The communication device may have a communication interface for the transmission and/or reception.

The connection can be implementable by the user, and in particular in a releasable, in particular non-destructively releasable, manner and/or in a contact-based manner and/or mechanically.

The energy storage device may be electrochemical and/or a battery, in particular a button cell, in particular a CR 2032 or CR 2450 button cell.

Electrical contacts of the communication device can directly touch electrical contacts of the energy storage device when connected to the energy storage device or by establishing the connection to the energy storage device.

The phrase "simultaneous with" can be used synonymously for the term "during".

The term "consists of" or "has" can be used synonymously for the term "comprises".

The term “enable”, “release”, “operate” or “activate” can be used synonymously for the term "transfer".

The term element "mode" can be used synonymously for the term element "state".

The term "due to" can be used synonymously for the term "triggered".

The transfer of the communication device to the configuration state can be triggered by, in particular not until, a connection has been established to the energy storage device multiple times, such as twice, three times, four times or five times, for a limited period of time or in quick succession. In addition or alternatively, the communication device, in particular wherein the energy storage device supplies the communication device with energy, can be designed to check, before the transfer of the communication device to the configuration state, whether the transfer to the configuration state, in particular the configuring, of the communication device has already been carried out. This prevents the key, which in particular has already been received and accepted, from being overwritten if it is not intended to configure the communication device again.

The communication device may be designed to receive the key in the configuration state. In addition or alternatively, the communication device may be designed to accept the key received in the configuration state.

The term "adopt" can be used synonymously for the term "accept".

Accepting may comprise, in particular be, storing, in particular in the memory of the communication device. In addition or alternatively, the accepting may comprise processing, in particular in the form of depositing the key in a set of keys and/or verifying the validity and/or origin and/or format of the key.

The communication device may not or need not be designed to receive the key nor to accept the received key when not in the configuration state. In addition or alternatively, the communication device may be designed for a reset, in particular only with the key received previously or beforehand in the form of a soft reset, when not in the configuration state.

Step a) can be carried out by means of the communication device and/or directly or without a pause after the connection has been established.

Step b) can be executed after step a).

Step c) can be executed, in particular directly, after step b).

The term "take place" or the phrase "be carried out" or "be implemented" can be used synonymously for the phrase "be executed".

Reference is also made to the technical literature.

In a refinement of the invention, the communication device is designed in or from the configuration state to independently transfer itself to a non-configuration state triggered by, in particular exactly, the expiry of a time period, in particular limited at the factory, since the, in particular last, establishment, in particular start of the establishment, of the connection to the energy storage device and/or since the, in particular last, transfer, in particular start of the transfer, to the configuration state. The communication device in the non-configuration state is designed not to receive the key or not to accept the received key, in particular not to perform the configuration such that the non-configured communication device is not configured for processing the data with the key and for sending the processed data. In particular, the duration is a maximum of 120 s (seconds), in particular a maximum of 90 s, in particular a maximum of 60 s, in particular 30 s. This enables a high level of security during configuration. In particular, this can be carried out independently without the user.

In addition or alternatively, the transfer can be automatic and/or computer-implemented. In addition or alternatively, the terms "block", "leave" or "deactivate" can be used synonymously for the term "transfer". Also, in addition or alternatively, the term "reaching" can be used synonymously for the term "expiry".

Further, in addition or alternatively, the term "specified" or "predetermined" can be used synonymously for the term "limited".

Further, in addition or alternatively, the term element "period" can be used synonymously for the term element "duration" of the term "time duration".

In addition or alternatively, the duration may be greater than 0 s, in particular a minimum of 1 s, in particular a minimum of 2 s, In particular, a minimum of 5 s.

Further, in addition or alternatively, the communication device can be designed not to receive the key in the non-configuration state or not to accept the key received in the non-configuration state.

Further, in addition or alternatively, the transfer can be carried out by means of the communication device and/or directly after the expiry of the time period. Reference is also made to the technical literature.

In a refinement of the invention, the communication device, in particular wherein the energy storage device supplies the communication device with energy, is designed to output, in particular optically, acoustically and/or haptically, information about the transfer to the configuration state in a manner perceptible by the user and/or to output, in particular different, information about the transfer to the non-configuration state in a manner perceptible by the user. This allows for intuitiveness and thus simplicity of the configuration. In particular, the output can be automatic and/or computer-implemented. In addition or alternatively, the information may have a value and/or content. Further, in addition or alternatively, the communication device can have at least one display, in particular an LED, for the optical output, such as a green and/or flashing LED for the optical output of the information about the transfer to the configuration state and/or a red and/or permanently lit LED for the optical output of the information about the transfer to the non-configuration state. Reference is also made to the technical literature.

In a refinement of the invention, the key is transmitted wirelessly from a user device, in particular triggered by the user. The user device is different, and in particular separate, from the processing device, the communication device and the energy storage device. This enables the key to be received by means of the communication device in the configuration state. In particular, the term “external communication remote station” can be used synonymously for the term "user device". In addition or alternatively, the term "provided" can be used synonymously for the term "transmitted". Reference is also made to the technical literature.

In one embodiment of the invention step a) comprises: wirelessly transmitting information to the user device about the transfer to the configuration state by means of the communication device, triggered by, in particular precisely, the establishment of the connection to the energy storage device, wherein the energy storage device supplies the communication device with energy. The method comprises the steps of:

- wirelessly receiving the transmitted information by means of the user device; and

- wirelessly transmitting the key to the communication device, triggered by, in particular precisely, the receipt of the information.

This allows for simplicity of the configuration. In particular, the sending and/or receiving can be independent, automatic and/or computer-implemented. In addition or alternatively, the information may have a value and/or content. Further, in addition or alternatively, the information can be transmitted directly after the connection has been established. Further, in addition or alternatively, the key can be transmitted directly after the information has been received. Reference is also made to the technical literature.

In one embodiment of the invention, the user device comprises an, in particular mobile, terminal device and/or an, in particular mobile, gateway. In particular, the user device is the terminal device and/or the gateway. This allows for simplicity of the configuration. In particular, the user may be an end user. In addition or alternatively, the terminal device may be a mobile phone, a notebook, a smartphone, a smartwatch and/or a tablet computer. Further, in addition or alternatively, the user device may obtain the key from a backend, in particular a database, in particular a cloud. Further, in addition or alternatively, the user device may comprise an app for the configuration. Also, in addition or alternatively, the term "portable" can be used synonymously for the term "mobile". Reference is also made to the technical literature.

In a refinement of the invention, the method comprises the step of: d) transferring the configured communication device to an operating state triggered by, in particular precisely, the configuring of the communication device. The communication device in the operating state is designed for bidirectional wireless communication, in particular with the user device, and in particular the backend. In particular, the transfer can be independent, automatic and/or computer-implemented. In addition or alternatively, the transfer can be carried out by means of the communication device and/or directly after the configuration of the communication device or step c). In addition or alternatively, the non-configured communication device may not or need not be transferred to the operating state. In other words, the non-configured communication device may not or need not be designed to communicate. Further, in addition or alternatively, the communication may comprise, in particular be, the transmission of the processed data. Reference is also made to the technical literature.

In particular, the communication device may be in, in particular, either the configuration state, the non-configuration state or the operating state, in particular at a given time.

In particular, the non-configured communication device may be in the configuration state after the connection to the energy storage device has been established by a user until a cryptographic key can be received.

In addition or alternatively, the configured communication device may have the operating state, in particular be in the operating state, wherein the communication device can be designed to be transferred to the configuration state by the user by establishing the connection to the energy storage device. In particular, the configured communication device may be in the non-configuration state after the expiry of the time period, wherein in this case the non-configuration state can correspond to the operating state.

In a refinement of the invention, the transmission, reception, sending and/or communication are based on a short-range technology. In particular, the technology has a maximum range of 10 m (meters) and/or comprises Bluetooth technology and/or ZigBee technology and/or Wireless Local Area Network technology. In particular, the technology is Bluetooth technology and/or ZigBee technology and/or Wireless Local Area Network technology. This allows a high level of security of the configuration. Reference is also made to the technical literature.

In a refinement of the invention, the communication device comprises a housing. The housing is designed to receive the energy storage device and has an open state and a closed state. In the open state, the energy storage device can be inserted into the housing and/or removed from the housing, in particular by the user. In particular, the housing has a container for receiving the energy storage device and a lid, which can be mounted in particular on top of the container, to provide closure of the container. In the open state, the lid is removed from the container and in the closed state the lid closes the container, in particular in a fluid-tight manner. In particular, the container and the lid have at least one bayonet closure for a mechanical connection with each other, in particular in the closed state of the housing. This allows for ease of establishing the connection and/or security of the established connection. In particular, the housing may be designed such that its state can be changeable between open and closed, in particular non-destructively, in particular by the user. In addition or alternatively, the term "placeable" can be used synonymously for the term "insertable". Further, in addition or alternatively, the lid may be mechanically connected to the container in the closed state. Reference is also made to the technical literature.

In particular, the communication device may be a part of the processing device.

In addition or alternatively, the communication device, the energy storage device and the processing device may be different.

In a refinement of the invention, the communication device and the energy storage device are designed separately from the processing device. Additionally or alternatively, the communication device, in particular wherein the energy storage device supplies the communication device with energy, is designed, at least in an off-state of the drive motor of the processing device, in particular in an inoperable state of the processing device, at least for transmission, and in particular for processing. This, in particular the separation, allows a retrofitting of the communication device on the processing device, in particular after a delivery of the processing device from the factory. In addition or alternatively, this enables at least the transmission, and in particular the processing, independently of an operability state of the processing device, in particular the ON state of the drive motor.

In particular, the term “communication unit” can be used synonymously for the term "communication device". Additionally or alternatively, the communication device, in particular wherein the energy storage device supplies the communication device with energy, can be designed, in the inoperable state of the processing device, in particular the ON state of the drive, at least for transmission, and in particular processing and/or storage. Further, in addition or alternatively, the inoperability state may be caused by the absence of a drive energy source, in particular a lack of connection to a drive accumulator. Reference is also made to the technical literature.

In particular, the communication device and the energy storage device may not or need not be designed to form an, in particular contact-based, electrical connection to the processing device.

In addition or alternatively, the communication device may be designed to collect the data from the processing device contactlessly or wirelessly, in particular regardless of whether the processing device has an electric drive motor or a combustion drive motor, and/or wherein the communication device can have an inductive sensor for the data collection. For example, it may be possible by means of the sensor to detect changing electromagnetic and/or magnetic fields, for example caused by stray fields of electric motors, accumulators, ignition pulses of combustion engines, current changes, moving magnets in a flywheel of the processing device, a generator, etc. This allows the data to be collected reliably and independently of a drive type of the processing device, since the changing electromagnetic and/or magnetic fields can only arise during operation of the processing device.

In a refinement of the invention, the data comprises operating data, in particular an operating duration of the ON state of the drive motor of the processing device. In particular, a time stamp can be assigned to each of the operating data items. In addition or alternatively, the term "operating hours" or “running time” can be used synonymously for the term "operating duration". Reference is also made to the technical literature.

In particular, the data can comprise diagnostic data, time stamps, statistical data, parameters of the processing device, measured values and/or additional cryptographically processed data, most particularly additional cryptographic keys.

The method according to the invention is intended for, in particular, configuring the communication device by means of the user device. The method comprises the steps of:

- wirelessly receiving the information by means of the user device, wherein the information is about the transfer of the communication device to the configuration state, wherein the communication device in the configuration state is designed to wirelessly transmit the information;

- wirelessly transmitting the key to the communication device by means of the user device, triggered by receiving the information. The communication device in the configuration state can be configured at least with the transmitted key.

In particular, the method can be independent, automatic and/or computer-implemented.

The communication device according to the invention is designed, in particular, to perform the configuration. The communication device is at least suitable for:

- arrangement on the motor-driven processing device,

- collecting the data from the processing device,

- cryptographically processing the collected data with the cryptographic key,

- wirelessly transmitting the processed data, and

- connecting to the electrical energy storage device for supplying the communication device with energy during the processing and transmission, and in particular the collection, of the data.

The communication device is designed to:

- transfer the communication device to the configuration state triggered by establishing the connection to the energy storage device by the user, in such a way that the energy storage device supplies the communication device with energy, wherein the communication device in the configuration state is designed to wirelessly receive the key and to accept the received key;

- wirelessly receive the key by means of the communication device in the configuration state;

- configure the communication device by means of the acceptance of the received key by means of the communication device, in such a way that the configured communication device is configured for processing the data with the key and transmitting the processed data.

The communication device may allow the same advantage(s) as for the method mentioned above. In particular, the communication device can be, in particular designed, for carrying out the method, in particular automatically. In addition or alternatively, the communication device can comprise a computer and/or a processor and/or a microcontroller and/or a memory and/or a computer. Reference is also made to the technical literature.

The system according to the invention comprises the communication device and the processing device, the energy storage device and/or the user device, and in particular the backend. In particular, the system, in particular comprising the user device, can be in particular designed to carry out the method, in particular automatically.

The computer program according to the invention is designed to execute the method, in particular automatically, in particular its steps, and/or by means of the communication device and/or by means of the system. The computer program may allow the same advantage(s) as for the method mentioned above. In particular, the computer program may be a computer program product. In addition or alternatively, the computer program can be stored on a computer-readable (storage) medium. In other words: the computer program can comprise commands or instructions, in particular executable by means of the communication device and/or the system, in particular which during execution or when executed by means of the communication device and/or the system, cause or induce this to carry out the method. Again, in other words: the commands can describe the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a system according to an embodiment of the invention comprising a communication device when carrying out a method according to an embodiment of the invention of a computer program;

FIG. 2 is a schematic exploded view of the communication device; and

FIG. 3 is a schematic functional flowchart of an embodiment of the method.

### DETAILED DESCRIPTION OF THE DRAWINGS

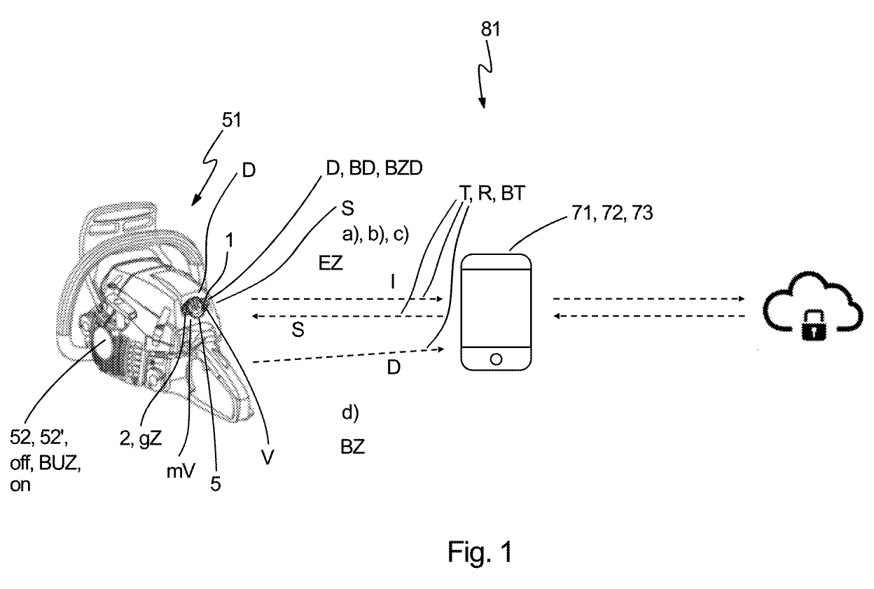

FIGS. 1 to 3 show a method of a computer program and a system 81 comprising a communication device 1 for configuring, in particular once, the communication device 1, in particular by means of a user device 71.

The communication device 1 is at least suitable for:

- arrangement on a motor-driven processing device 51, in particular is arranged,

- collecting data D from the processing device 51, in particular collects,

- cryptographically processing the collected data D with a cryptographic key S, in particular processes,

- wirelessly transmitting the processed data D, in particular sends, and

- connecting V to an electrical energy storage device 61 for supplying the communication device 1 with energy during the processing and transmission, and in particular the collection of the data D, in particular comprises the connection V.

The method for configuring the communication device 1 comprises the steps of:

a) transferring the communication device 1 to a configuration state EZ triggered by establishing the connection V to the energy storage device 61 by a user, in such a way that the energy storage device 61 supplies the communication device 1 with energy, wherein the communication device 1 in the configuration state EZ is designed to wirelessly receive the key S and to accept the received key S;

b) receiving the key S by means of the communication device 1 in the configuration state EZ;

c) configuring the communication device 1 by means of the acceptance of the received key S by means of the communication device 1, in such a way that the configured communication device 1 is configured for processing the data D with the key S and transmitting the processed data D.

The communication device 1 is designed to:

transfer the communication device 1 to the configuration state EZ triggered by establishing the connection V to the energy storage device 61 by the user, in such a way that the energy storage device 61 supplies the communication device 1 with energy, in particular transfers, wherein the communication device 1 in the configuration state EZ is designed to wirelessly receive the key S and to accept the received key S;

wirelessly receive the key S by means of the communication device 1 in the configuration state EZ, in particular receive;

configure the communication device 1 by means of the acceptance of the received key S by means of the communication device 1, in such a way that the configured communication device 1 is configured for processing the data D with the key S and transmitting the processed data D, in particular accepts and configures.

In detail, the communication device 1 in the configuration state EZ is designed to perform an independent transfer to a non-configuration state NEZ triggered by, in particular precisely, an expiry of a limited time period ZD since the establishment of the connection V to the energy storage device 61 and/or the transfer to the configuration state EZ, as shown in FIG. 3, in particular transfers. The communication device 1 in the non-configuration state NEZ is designed not to receive the key S or not to accept the received key S, in particular not to perform the configuration in such a way that the non-configured communication device 1 is not configured for processing the data D with the key S and transmitting the processed data D, in particular does not receive or accept and does not configure. In particular, the time duration ZD is a maximum of 120 s, in particular a maximum of 90 s, in particular a maximum of 60 s, in particular 30 s.

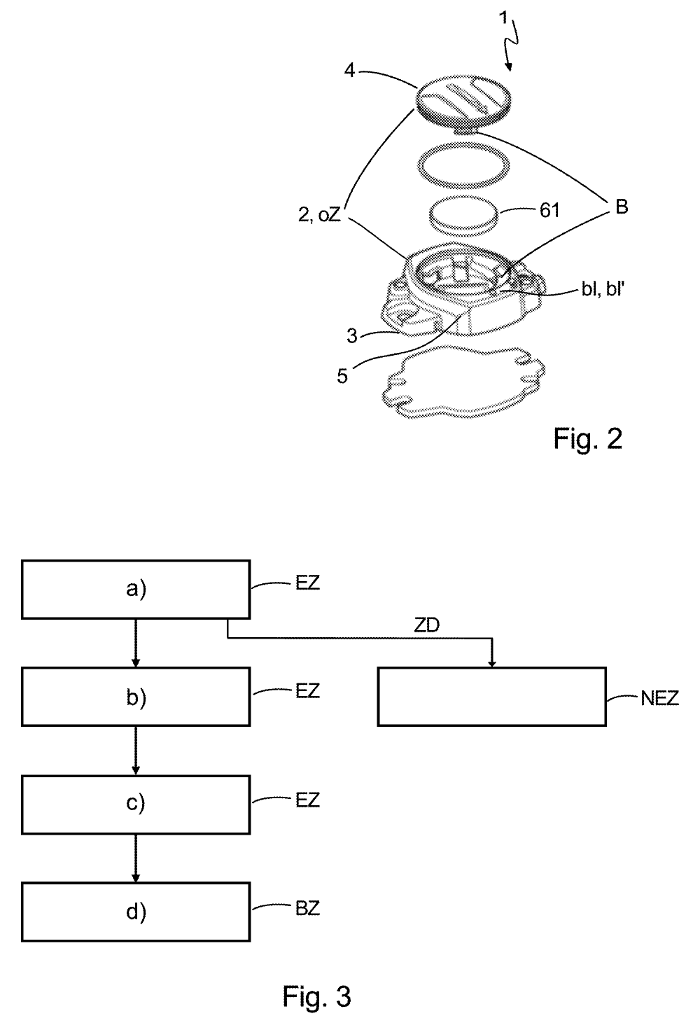

Furthermore, the communication device 1, in particular wherein the energy storage device 61 supplies the communication device 1 with energy, is designed to output, in particular optically, acoustically and/or haptically, information bI about the transfer to the configuration state EZ in a manner perceptible by the user and/or to output, in particular different, information bI’ about the transfer to the non-configuration state NEZ in a manner perceptible by the user, as shown in FIG. 2, in particular outputs.

In addition, the key S is transmitted from the user device 71 wirelessly, as shown in FIG. 1. The user device 71 is different from the processing device 51, the communication device 1 and the energy storage device 61.

In detail, step a) comprises: wirelessly transmitting information I to the user device 71 about the transfer to the configuration state EZ by means of the communication device 1, triggered by the establishment of the connection V to the energy storage device 61, wherein the energy storage device 61 supplies the communication device 1 with energy. The method comprises the steps of:

wirelessly receiving the transmitted information I by means of the user device 71; and

wirelessly transmitting the key S to the communication device 1 triggered by the receipt of the information I.

Further, the user device 71 comprises an in particular mobile terminal device 72 and/or an in particular mobile gateway 73. In particular, the user device 71 is the terminal device 72 and/or the gateway 73.

In particular, the user device obtains the key S from a backend.

In addition, the method comprises the step of: d) transferring the configured communication device 1 to an operating state BZ triggered by the configuration of the communication device 1. The communication device 1 in the operating state BZ is designed for bidirectional wireless communication, in particular with the user device 71, and in particular the backend, in particular communicates.

Furthermore, the transmission, reception, sending and/or communication is/are based on a short-range technology T. In particular, the technology T has a maximum range R of 10 m and/or comprises Bluetooth technology BT and/or ZigBee technology and/or Wireless Local Area Network technology. In particular, the technology T is Bluetooth technology BT and/or ZigBee technology and/or Wireless Local Area Network technology.

In addition, the communication device 1 has a housing 2. The housing 2 is designed to receive the energy storage device 61, in particular receives, and has an open state oZ as shown in FIG. 2, and a closed state gZ as shown in FIG. 1. In the open state oZ, the energy storage device 61 can be inserted into the housing 2 and/or removed from the housing 2. In particular, the housing 2 comprises a container 3 for receiving the energy storage device 61 and a lid 4 for closing the container 3. In the open state oZ the lid 4 is removed from the container 3 and in the closed state gZ the lid 4 closes the container 3. In particular, the container 3 and the lid 4 have at least one bayonet closure B to form a mechanical connection mv to each other.

Further, the communication device 1 and the energy storage device 61 are designed separately from the processing device 51. In addition or alternatively, the communication device 1, in particular wherein the energy storage device 61 supplies the communication device 1 with energy, is designed, at least in an off-state off of a drive motor 52 of the processing device 51, in particular in an inoperable state BUZ of the processing device 51, at least for transmission, and in particular for processing.

In addition, the data D comprises operating data BD, in particular an operating duration BZD of an ON state on of the drive motor 52 of the processing device 51.

Furthermore, the method for configuring the communication device 1 by means of the user device 71 comprises the steps of:

- wirelessly receiving the information I by means of the user 71, wherein the information I is about the transfer of the communication device 1 to the configuration state EZ, and wherein the communication device 1 in the configuration state EZ is designed to wirelessly transmit the information I;

wirelessly transmitting the key S by means of the user device 71 to the communication device 1, triggered by the receipt of the information I, wherein in the configuration state EZ the communication device 1 can be configured at least with the transmitted key S.

In addition, the system 81 comprises the processing device 51, the energy storage device 61 and/or the user device 71, and in particular the backend.

As the exemplary embodiment shown and described above makes clear, the invention provides an advantageous method for configuring a communication device, an advantageous method for configuring a communication device by means of a user device, an advantageous communication device, an advantageous system comprising such a communication device and an advantageous computer program for carrying out such a method and/or by means of such a communication device and/or by means of such a system, which have/has improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for configuring a communication device that is suitable for:
arrangement on a motor-driven processing device,
collecting data from the motor-driven processing device,
cryptographically processing the collected data with a cryptographic key,
wirelessly transmitting the processed data, and
connecting to an electrical energy storage device for supplying the communication device with energy during the collecting, cryptographic processing and wireless transmission of the data,
the method comprising the steps of:
a) transferring the communication device to a configuration state triggered by establishing the connection to the energy storage device by a user, such that the energy storage device supplies the communication device with energy, wherein in the configuration state the communication device is configured to wirelessly receive the cryptographic key and to accept the received cryptographic key;
b) receiving the cryptographic key by the communication device in the configuration state; and
c) configuring the communication device by accepting the received cryptographic key such that the configured communication device is configured for processing the data with the cryptographic key and transmitting the processed data.

2. The method as claimed in claim 1,
wherein, in the configuration state, the communication device is configured to independently transfer itself into a non-configuration state triggered by an expiry of a limited time period since the establishment of the connection to the energy storage device and/or since the transfer to the configuration state,
wherein in the non-configuration state the communication device is configured not to receive the cryptographic key or not to accept the received cryptographic key,
wherein the time duration is a maximum of 120 s.

3. The method as claimed in claim 1,
wherein the communication device is configured to output optically, acoustically and/or haptically, information about the transfer to the configuration state in a manner perceptible by the user, and/or to output different information about the transfer to the non-configuration state in a manner perceptible by the user.

4. The method as claimed in claim 1,
wherein the cryptographic key is transmitted wirelessly from a user device, which is different from the motor-driven processing device, the communication device and the energy storage device.

5. The method as claimed in claim 4,
wherein step a) comprises: wirelessly transmitting information to the user device about the transfer to the configuration state by the communication device, triggered by the establishment of the connection to the energy storage device, wherein the energy storage device supplies the communication device with energy, and
the method further comprising the steps of:
wirelessly receiving transmitted information by the user device; and
wirelessly transmitting the cryptographic key to the communication device triggered by the receipt of the transmitted information.

6. The method as claimed in claim 4, wherein
the user device comprises a mobile terminal device and/or a mobile gateway.

7. The method as claimed in claim 1, further comprising the step of:
d) transferring the configured communication device to an operating state triggered by the configuring of the communication device, wherein
in the operating state, the communication device is configured for bidirectional wireless communication with the user device.

8. The method as claimed in claim 7, wherein
the transmission, the reception, the sending and/or the communication is/are based on a short-range technology.

9. The method as claimed in claim 8, wherein the short-range technology has a maximum range of 10 m and/or comprises Bluetooth technology, ZigBee technology, and/or Wireless Local Area Network technology.

10. The method as claimed in claim 1, wherein
the communication device comprises a housing, which is configured to accommodate the energy storage device and has an open state and a closed state, wherein in the open state the energy storage device is insertable into the housing and/or removable from the housing.

11. The method as claimed in claim 10, wherein
the housing comprises a container for receiving the energy storage device and a lid for closing the container,
the lid is removable from the container in the open state and the lid closes the container in the closed state, and
the container and the lid have at least one bayonet closure to form a mechanical connection with each other.

12. The method as claimed in claim 1,
wherein the communication device and the energy storage device are designed separately from the motor-driven processing device, and/or
wherein the communication device, when the energy storage device supplies the communication device with energy, is designed, at least in an off-state of a drive motor of the motor-driven processing device, for transmission and for processing.

13. The method as claimed in claim 1, wherein the data comprises operating data of the motor-driven processing device.

14. The method as claimed in claim 13, wherein the data is an operating duration of an ON state of a drive motor of the motor-driven processing device.

15. A method for configuring a communication device via a user device, the method comprising the steps of:
wirelessly receiving information by the user device, the information being about a transfer of the communication device to a configuration state, wherein in the configuration state the communication device is configured to wirelessly transmit the information; and
wirelessly transmitting a cryptographic key from the user device to the communication device triggered by the reception of the information, wherein in the configuration state the communication device is configurable at least with the transmitted cryptographic key.

16. A device to be configured, comprising:
a communication device suitable at least for:
arrangement on a motor-driven processing device,
collecting data from the motor-driven processing device,
cryptographically processing the collected data with a cryptographic key,
wirelessly transmitting the processed data, and
connecting to an electrical energy storage device for supplying the communication device with energy during the collection, processing and transmission of the data,
wherein the communication device is configured to:
transfer the communication device to a configuration state triggered by establishing the connection to the energy storage device by a user, such that the energy storage device supplies the communication device with energy, wherein in the configuration state the communication device is configured to wirelessly receive the cryptographic key and accept the received cryptographic key,
receive the cryptographic key by way of the communication device in the configuration state, and
configure the communication device by the acceptance of the received cryptographic key by the communication device, such that the configured communication device is configured for processing the data with the received cryptographic key and transmitting the processed data.

17. A system, comprising:
the communication device as claimed in claim 16; and
the motor-driven processing device, the energy storage device and/or a user device.

18. A computer product comprising a non-transitory computer-readable medium having stored thereon program code which, when executed by a processor, causes the acts of:
a) transferring a communication device, arrangeable on a motor-driven processing device, to a configuration state triggered by establishing a connection to an energy storage device by a user, such that the energy storage device supplies the communication device with energy, wherein in the configuration state the communication device is configured to wirelessly receive a cryptographic key and to accept the received cryptographic key,
b) receiving the cryptographic key by the communication device in the configuration state, and
c) configuring the communication device by accepting the received cryptographic key such that the configured communication device is configured for processing data, collectable from the motor-driven processing device, with the cryptographic key and transmitting the processed data.
